(19) United States
(12) Patent Application Publication
(10) Pub. No.: US 2002/0097692 A1
(43) Pub. Date: Jul. 25, 2002

(54) User interface for a mobile station

(75) Inventor: Kimmo Ruotoistenmaki, Oulu (FI)

Correspondence Address: Clarence A. Green, PERMAN & GREEN, LLP, 425 Post Road, Fairfield, CT, 06430, US

(73) Assignee: Nokia Mobile Phones Ltd.

(21) Appl. No.: 09/766,147

(22) Filed: Jan. 19, 2001

Related U.S. Application Data
(60) Provisional application No. 60/259,122, filed on Dec. 29, 2000.

(51) Int. Cl. H04Q 7/00

(52) U.S. Cl. 370/328; 370/352

(57) ABSTRACT

The invention relates to providing a user interface for a mobile station. In particular the invention relates to a speech user interface. The objects of the invention are fulfilled by providing a speech user interface for a mobile station, in which a conversion between speech and another form of information is applied in the communication network. The other form of information is e.g. text or graphics. The user interface communication between the mobile station and the network is preferably implemented with Voice over Internet Protocols, and therefore this conversion service can be dedicated to and permanently available for the mobile station, so other types of interfaces like keyboard or display are not necessarily needed.

### CROSS-REFERENCE TO RELATED APPLICATION

This application claims the benefit of U.S. Provisional Application, Express Mail No.: EL336866736US mailed on Dec. 29, 2000, which is incorporated by reference herein in its entirety.

### TECHNICAL FIELD OF THE INVENTION

The invention relates to providing a user interface for a mobile station. Especially the invention relates to a speech user interface. The invention is directed to a user interface, a method for providing a user interface, a network element and a mobile station according to the preambles of the independent claims.

### BACKGROUND OF THE INVENTION

In mobile terminals, speech recognition has mainly been in use in speech dialer applications. In such an application a user pushes a button, says the name of a person and the phone automatically calls to the desired person. This kind of arrangement is disclosed in document EP 0746129; “Method and Apparatus for Controlling a Telephone with Voice Commands” [1]. The speech dialer is practical for implementing a handsfree operation for a mobile station. In future, different kinds of command-and-control user interfaces are likely to be developed. In this kind of applications, vocabulary doesn't have to be dynamically changeable, since the same command words are used over and over again. However, this is not the case in a feasible voice browsing application, where the active vocabulary has to be dynamic.

The evolution of speech oriented user interfaces has created many possibilities for new services and applications for desktop PCs (Personal Computer) as well as for mobile terminals. The improvement of basic technologies, such as Automatic Speech Recognition (ASR) and Text-To-Speech (TTS) technologies, has been significant.

Development of voice browsing and related markup languages and interpreters bring possibilities to introduce new (platform indepeded) speech applications. Numerous voice portal services taking advance of these new technologies have been published. For example, document U.S. Pat. No. 6,009,383; “Digital Connection for Voice Activated Services on Wireless Networks” [2] discloses a solution for implementing a voice serving node with a speech interface for providing a determined service for wireless terminal users. Document WO 00/52914; “System and Method for Internet Audio Browsing Using A Standard Telephone” [3] discloses a system where a standard telephone can be used for browsing the Internet by calling an audio Internet service provider which has a speech Interface.

However, there are certain disadvantages and problems related to the prior art solutions that were described above.

Let us first examine the idea of handsfree and eyesfree operation (e.g. when driving a car) by using a speech interface. The processing capacity of standard mobile stations is limited and therefore the functionality of the speech recognition would be very limited. If there would be well functioning speech recognition capabilities implemented in the phone, this would increase the requirement of processing capacity and memory capacity of the mobile station, and thus the price of the mobile station would tend to become high. This also concerns TTS algorithms, which require high memory and processing capacity.

There is also another problem, which relates to a speech recognition function that is implemented in a mobile station. Operators want to be able to bring their user interface features or even applications of their own to the phone. While the same terminal should be able to be sold for different operators in several e.g. lingual areas, there should be a way to modify the user interface easily. Typically, if a new user interface feature is wanted, the software has to be flashed. Also downloadable features are under development. However, providing a mobile station with a large-sized program for speech recognition makes the availability of several software versions and updating the software difficult. And this is in addition to the fact that the user interface of a mobile station in general tends to require an extensive amount of design, implementation and updating work.

Then let us examine the idea of using a network based voice browser (Voice portals). This kind of services enable the user e.g. to check a calendar or to request a call while driving a car. The advantage of the solution is that it does not require high processing capacity because the speech recognition is made in the network based voice browser. In traditional systems as described in [2] and [3] above, the entire speech recogniser lies on the server appliance. It is therefore forced to use incoming speech in whatever condition it arrives in after the network decodes the vocoded speech. A solution that combats this uses a scheme called Distributed Speech Recognition (DSR). In this system, the remote device acts as a thin client in communication with a speech recognition server. The remote device processes the speech, compresses, and error protects the bitstream in a manner optimal for speech recognition. The server then uses this representation directly, minimising the signal processing necessary and benefiting from enhanced error concealment. The standardisation of distributed speech recognition enables state-of-art speech recognition in terminals with small memory and processing capabilities.

However, a problem with this solution relates to the fact that the voice browser of the server is accessed over the circuit switched telephone network and the line must be dialed and kept active for a long time. This tends to cause high operator expenses for the user, especially when using a mobile phone.

### SUMMARY OF THE INVENTION

The object of the invention is to achieve improvements related to the aforementioned disadvantages and problems of the prior art.

The objects of the invention are fulfilled by providing a speech user interface of a mobile station, in which a conversion between speech and another form of information is applied at least in part in the communication network. The other form of information is e.g. text, graphics or codes. The user interface communication between the mobile station and the network is preferably implemented with Voice over Internet Protocols, and therefore this conversion service can be dedicated to and permanently available for the mobile station, so other types of interfaces like keyboard or display are not necessarily needed.

A method according to the invention for providing a user interface for a mobile station that connects to a communication system, is characterized in that

conversion is made between acoustic and electric speech signals in the mobile station,

speech signals are transferred between the mobile station and the communication system,

information is converted between speech and a second form of information,

wherein the conversion between speech and the second form of information is made at least in part in the communication system.

A user interface according to the invention for a mobile station of a communication system is characterized in that the user interface comprises

means for converting speech signals between acoustic and electric forms,

means for transferring speech signals or derivative signals thereof between the mobile station and the communication system,

means for converting between speech and a second form of information, and

wherein

the means for converting between speech and the second form of information are provided at least in part in the communication system.

A network element according to the invention for providing an interface between a mobile station and a communication system, is characterized in that for providing a user interface of the mobile station it comprises

means for transmitting/receiving speech signals or derivative signals thereof to/from the mobile station, and

means for converting between speech or derivative thereof and a second form of information.

A mobile station according to the invention, which connects to a communication system, is characterized in that for providing a user interface of the mobile station it comprises

means for converting speech signals between acoustic and electric forms, and

means for transmitting/receiving speech signals or derivative signals thereof to/from the communication system for processing in the signals in the communications system in order to provide a user interface for the mobile station.

Preferred embodiments of the invention are described in the dependent claims.

In this application “user interface of the mobile station” means a user/mobile station specific permanent-type user interface in contrast to e.g. user interfaces of external services such as Internet services.

The present invention offers several important advantages over the prior art solutions.

Since the speech resources reside in the network, the state-of-art technologies with no actual memory or processing capacity limits can be used. This enables continuous speech recognition, Natural Language understanding and better quality TTS synthesis. A more natural speech user interface can thus be developed. A DSR system provides more accurate speech recognition compared to a telephony interface.

The use of packet network and VoIP session protocols makes it possible to be connected all the time to the voice browser in the network. The network resources are used only when actual data must be sent, e.g. when speech is transferred and processed.

The invention brings in the possibility to create a totally new type of mobile terminal where the user interface is purely speech oriented. In this exemplary embodiment of the invention no keypad or display is needed, and the size of the simplest terminal can be reduced to fit even in a headset that has a microphone, a speaker, a small power source, an RF transmitter and a microchip. The user interface is a speech dialogue based and resides totally in the network. Therefore it can be easily modified by the user or by the network operator. Voice browsing markups can be used to create the speech user interface. The user interface can be accessed, as well as normal voice calls, via packet network and VoIP protocol(s). On top of it, DSR and low bit-rate speech codecs can be used to minimize the use of air-interface. The solution does, however, not exclude the possibility to use a keypad or a display as well.

The terminal according to the invention can be made very simple. Therefore the hardware and software production costs are significantly lower. The user interface is easy to develop and update because it is developed with markup and resides actually in the network. The user interface can also be modified just the way user or operator wants and it can be remodified anytime.

The invention can be implemented for example in Wireless Local Area Network (WLAN) environment e.g. in office buildings, airports, factories etc. The invention can, of course, be implemented in mobile cellular communication systems, when the mobile packet networks become capable for realtime applications. Also so-called Bluetooth technology is applicable in implementing the invention.

### BRIEF DESCRIPTION OF THE DRAWINGS

Next the invention will be described in greater detail with reference to exemplary embodiments in accordance with the accompanying drawings, in which

FIG. 1 illustrates a block diagram of architecture for an exemplary arrangement for providing the user interface according to the invention,

FIG. 2 illustrates an exemplary telecommunication system where the invention can be applied.

### DETAILED DESCRIPTION

The following abbreviations are used herein:

ASIC Application Specific Integrated Circuit

ASR Automatic Speech Recognition

DSR Distributed Speech Recognition

ETSI European Telecommunications Standards Institute

GUI Graphical User Interface

H.323 VoiP protocol by ITU

IETF Internet Engineering Task Force

ITU International Telecommunication Union

IP Internet Protocol

LAN Local Area Network

RF Radio Frequency

RTP Transport Protocol for Real-Time Applications

RTSP Real Time Streaming Protocol

SIP Session Initiation Protocol

SMS Short Message Service

TTS Text-To-Speech

UI User Interface

VoIP Voice over IP

WLAN Wireles Local Area Network

W3C World Wide Web Consortium

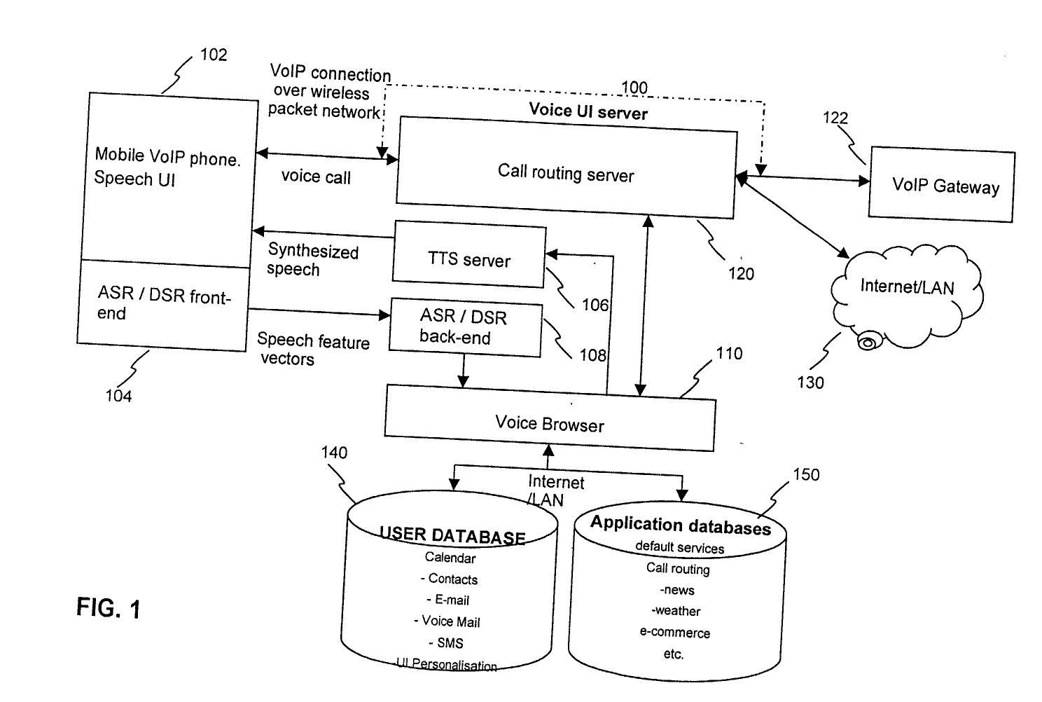

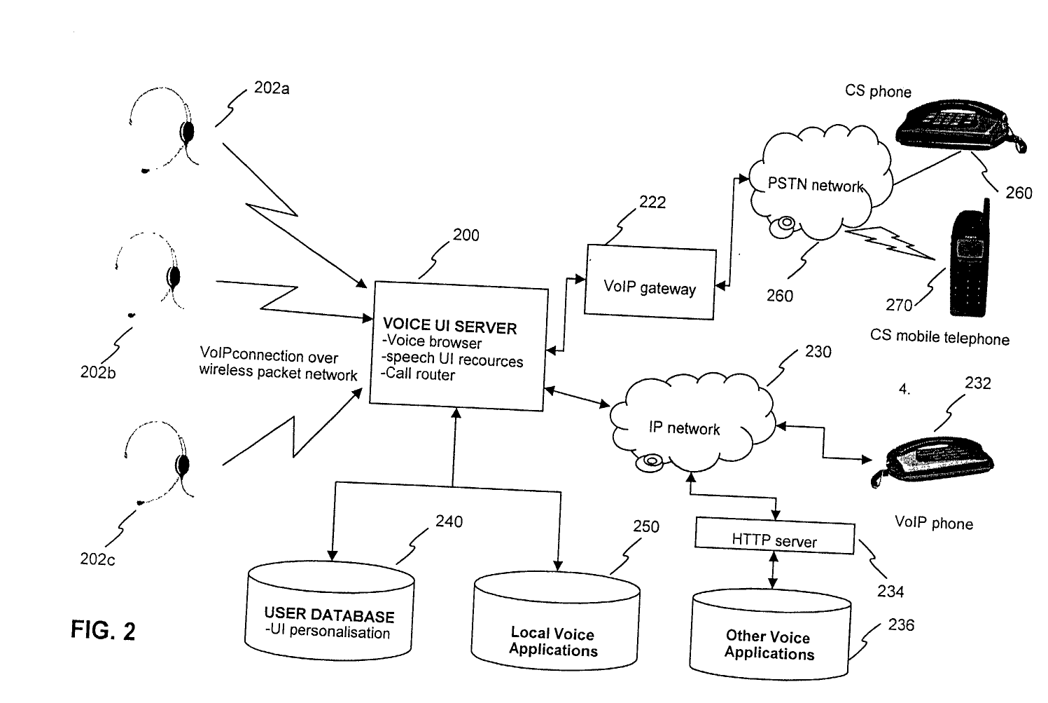

FIG. 1 illustrates architecture for an exemplary arrangement for providing the user interface according to the invention. FIG. 2 illustrates additional systems that may be connected to the architecture of FIG. 1.

The terminal 102, 104, 202a-202c may have very simple Voice over Internet Protocol capabilities 102 for providing a speech user interface, and ASR front-end 104. The VoIP capabilities may include session protocols such as SIP (Session Initiation Protocol) and H.323, as well as a media transfer protocol such as RTP (A Transport Protocol for Real-Time Applications). RTSP (Real Time Streaming Protocol) can be used to control the TTS output. The terminal can always tend to have a single VoIP connection to a Voice user interface server 100 when the terminal is switched on. The channels that are used between the terminal and the voice user interface server can be divided in to the following categories:

Speech channels for a normal voice call,

A channel for ASR feature vector transmission,

A speech channel for the Text-To-Speech output, and

Control channels.

The voice server network element 100 consists of a voice browser 110 with speech recognition 108 and synthesis 106 capabilities and thus provides a complete phone user interface. It also includes the call router 120. All the user data 140 such as calendar data, E-mail etc. can be accessed via the voice browser 110. The browser may access also third party applications via the Internet 130.

The user interface functionality is completely provided in the voice server 100, 200, which may acts as a personal assistant. All the commands can be given in sentences. Calls can be established by saying the number or the name. Text messages (E-mail, SMS) can be heard through the text-to-speech synthesis and can be answered by dictating the message. Calendar can be browsed, new data can be added, and so on.

Text-to-speech synthesis is processed in the TTS engine 106 in the network. The synthesized speech is converted into low bit-rate speech/audio codec and is (along with informative audioclips) sent to the terminal on top of VoIP connection. TTS may be implemented also in some distributed manner by preprocessing in the network and providing the end synthesis in the terminal.

DSR system 104, 108 is used for more accurate speech recognition compared to typically used telephony interface, where the speech is transferred via normal speech channel to the recognizer. DSR also saves air-interface since it takes less data to send speech in feature vectors than in speech codec. Speech feature vectors are sent on top of VoIP connection.

Normal voice call from terminal to other is established with the help of call router 120 (VoIP call manager). The user interface for e.g. dialing the call is still provided via the voice browser 110. Normal switched telephone network 260, 270 is accessed via a gateway 222, end-to-end VoIP calls 232 can be accessed via the packet network 230. Control channels are used to establish voice channels for a call.

The functionality of the user interface can be developed with voice browsing techniques such as VoiceXML (XML; eXtensible Markup Language), but other solutions such as script based spoken dialogue management can also be used. Voice browsing approach gives possibility to use basic World Wide Web technology to access third party applications in the network.

The terminal may have a button or two for most essential use. For example, button for initializing speech recognition.

The following is an example of a typical user interaction with the terminal.

USER: “Good Morning, What's for today?”

PHONE: “Good Morning. You have three appointments and four new messages . . . ”

USER: “Read the E-mail messages”

PHONE: “First message is from spam@spam.com . . . ”

USER: “Skip it”

PHONE: “Second message is from John Smith”

USER: “Let's hear it”

PHONE: “Subject: meeting at 9.00 in Frank. The message: Let's have meeting . . . ” (Reads the message)

USER: “Call to John Smith”

(Voice Server locates John's number from address book residing in database and establishes call. John answers. While normal call is active, speech recognition is not active.)

JOHN: “Hello, did you get my message? . . . ”

(Conversation goes on. It is decided to change the time of the meeting to the next morning)

JOHN: “OK, Bye!”

USER (Pushes a speech recognition button): “Bye!”

(One way to separate voice commands for the user interface from normal conversation with another person is the speech recognition button. When the button is pushed, “bye” acts as a command and the call is closed.)

USER: “Put a new meeting with Joluh Smith into my calendar for nine a.m. tomorrow. Place F205.

PHONE: “A new meeting. At 9 o'clock, 19th of August in meeting room F205. Subject: none. Is this correct?”

USER: “Yes, that's correct.”

PHONE “A new meeting saved”

USER: “Let's check appointments . . . ”

The invention can be implemented by using already existing components and technologies. The technology for modules of Voice Server already exists. The first commercial VoiceXML (XML; eXtensible Markup Language) browsers are presently attending the markets. Also older techniques of dialogue management can be used. In typical VoIP architecture, call management is done via a call router. SIP (Session Initiation Protocol) maybe the best VoIP protocol for the purpose. The SIP is specified in the IETF standard proposal RFC 2543; “SIP: Session Initiation Protocol” [4]. The SIP along with RTP is also one of the best solutions as a bearer for DSR feature vectors. The RTP is a transport protocol for real-time applications and it is specified in the IETF standard proposal RFC 1889; “RTP: A Transport Protocol for Real-Time Applications” [5]. Transfer of Distributed Speech Recognition (DSR) streams in the Real-Time Transport Protocol is specified in ETSI standard ES 201 108; “Distributed Speech Recognition (DSR) streams in the Real-Time Transport Protocol” [6]. A Real Time Streaming Protocol (RTSP), which can also be used for implementing the VoIP is specified in RFC 2326; “Real Time Streaming Protocol” [7].

Physically the electronics of the terminal may consist of just an RF (Radio Frequency) and ASIC (Application Specific Integrated Circuit) part attached to a headset. The terminal can thus easily be made almost invisible to others.

At the moment, the preferred way to implement the invention is in WLAN (Wireless Local Area Network), because the real time packet data transfer is available. WLAN is becoming more popular and in the future at least all office building will have WLAN. Internet operators are also building large WLAN environment into largest cities. VoIP phone is also used in WLAN networks. Later on, when the VoIP is possible on the mobile packet networks, they can be used for implementing the invention. Also so-called Bluetooth technology is applicable in implementing the invention.

The solution is ideal for small networks with limited amount of users. However, access to larger networks is provided. Since the terminal can be almost invisible and has multifunctional and automated applications, it can be used e.g. in surveillance purposes for security in airports, in factories etc. The simplest solution does not have keypad or display, but they can be introduced in the same product. All or some of the Graphical User Interface functionality could also be located in the network and terminal would only have a GUI browser. This GUI browser could synchronise with the voice browse in the network (Multimodality).

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

1. A method for providing a user interface of a mobile station that connects to a communication system, characterized in that
conversion is made between acoustic and electric speech signals in the mobile station,
speech signals are transferred between the mobile station and the communication system, and
information is converted between speech and a second form of information,
wherein the conversion between speech and the second form of information is made at least in part in the communication system.

2. A method according to claim 1, characterized in that substantially all user interface functions of the mobile station are made using said user interface.

3. A method according to claim 1, characterized in that the second form of information is text or graphics.

4. A method according to claim 1, characterized in that automatic speech recognition is used.

5. A method according to claim 1, characterized in that distributed speech recognition is used.

6. A method according to claim 1, characterized in that Voice over Internet Protocols are used in the user interface communication between the mobile station and the communication system.

7. A method according to claim 1, characterized in that user interface communication between the mobile station and the communication system is substantially continuously available for providing the user interface, when the mobile station is able to communicate with a base station of the communication system.

8. A method according to claim 1, characterized in that said information in the second form is transferred within the communication system.

9. A user interface of a mobile station of a communication system, characterized in that the user interface comprises
means for converting speech signals between acoustic and electric forms,
means for transferring speech signals or derivative signals thereof between the mobile station and the communication system,
means for converting between speech and a second form of information, and
wherein
the means for converting between speech and the second form of information are provided at least in part in the communication system.

10. A user interface according to claim 9, characterized in that said user interface provides for substantially all user interface functions of the mobile station.

11. A user interface according to claim 9, characterized in that the second form of information is text or graphics.

12. A user interface according to claim 9, characterized in that it comprises means for automatic speech recognition.

13. A user interface according to claim 9, characterized in that it comprises means for distributed speech recognition.

14. A user interface according to claim 9, characterized in that it comprises means for using Voice over Internet Protocols in the user interface communication between the mobile station and the communication system.

15. A user interface according to claim 9, characterized in that it comprises means for providing the user interface communication between the mobile station and the communication system to be substantially continuously available for providing the user interface, when the mobile station is able to communicate with a base station of the communication system.

16. A user interface according to claim 9, characterized in that it comprises means for transmitting/receiving said information in the second form to/from other parts of the communication system.

17. A network element for providing an interface between a mobile station and a communication system, characterized in that for providing a user interface of the mobile station it comprises
means for transmitting/receiving speech signals or derivative signals thereof to/from the mobile station, and
means for converting between speech or derivative thereof and a second form of information.

18. A network element according to claim 17, characterized in that it comprises means for transmitting/receiving said information in the second form to/from other parts of the communication system.

19. A network element according to claim 17, characterized in that it comprises means for using Voice over Internet Protocols in the user interface communication to/from the mobile station.

20. A network element according to claim 17, characterized in that it comprises a user database and/or an application database.

21. A network element according to claim 17, characterized in that it comprises a voice browser.

22. A mobile station, which connects to a communication system, characterized in that for providing a user interface of the mobile station it comprises
means for converting speech signals between acoustic and electric forms, and
means for transmitting/receiving speech signals or derivative signals thereof to/from the communication system for processing in the signals in the communications system in order to provide a user interface for the mobile station.

23. A mobile station according to claim 22, characterized in that it comprises means for transmitting/receiving speech signals or derivative signals thereof to/from the communication system using Voice over Internet Protocols for providing the user interface of the mobile station.

24. A mobile station according to claim 22, characterized in that said user interface provides for substantially all user interface functions of the mobile station.
